(19) United States
(12) Patent Application Publication
(10) Pub. No.: US 2025/0108365 A1
(43) Pub. Date: Apr. 3, 2025

(54) FUNCTIONALIZED POLYMER SEPARATOR MEMBRANE FOR MITIGATING TRANSITION METAL DISSOLUTION AND TRAPPING ACIDIC SPECIES

(71) Applicant: GM GLOBAL TECHNOLOGY OPERATIONS LLC, Detroit, MI (US)

(72) Inventors: Xingcheng Xiao, Troy, MI (US); Nathaniel Z. Hardin, Farmington Hills, MI (US); Ion C. Halalay, Grosse Pointe Park, MI (US)

(73) Assignee: GM GLOBAL TECHNOLOGY OPERATIONS LLC, Detroit, MI (US)

(21) Appl. No.: 18/357,107

(22) Filed: Jul. 22, 2023

(51) Int. Cl. B01J 39/05; B01J 39/19; B01J 47/12; C08G 69/32; C08G 69/48; C08J 5/22; H01M 50/403; H01M 50/423

(52) U.S. Cl. CPC B01J 39/05; B01J 39/19; B01J 47/12; C08G 69/32; C08G 69/48; C08J 5/2287; H01M 50/403; H01M 50/423; C08J 2377/06

(57) ABSTRACT

A functionalized polymeric separator membrane, including a polymer backbone chosen from an aramid-based polymer, a polyamide-based polymer, or a polyimide-based polymer, or combinations thereof; and further comprising one or more functional side groups (-FSG) capable of trapping transition metal ions and acidic species. The functionalized polymeric separator membrane may be a sulfonated polyaramid separator membrane. Sulfonation of polyaramid separators add functional groups that trap both acidic species and TM ions, thereby suppressing anode damage caused by TM deposition onto the anode by a two-step process. The functionalized polymer separator membranes may be used with Li-ion, Li-metal, or Sodium-ion batteries.

### INTRODUCTION

The present disclosure relates to functionalized polymeric separator membranes for use in rechargeable secondary batteries. More specifically, aspects of this disclosure relate to Lithium-ion, Lithium-metal, or Sodium-ion batteries for use in electric motor vehicles and other electric-powered devices. In particular, the disclosure relates to functionalized polymeric separator membranes having a polyaramid, polyamide, and/or polyimide backbone.

Rechargeable batteries may be used to power such diverse items as toys, consumer electronics, motor vehicles, and airplanes. A full-electric vehicle (FEV)—colloquially labeled an “electric vehicle”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an internal combustion engine-based vehicle are replaced with a single or multiple traction motors, rechargeable battery cans, and battery cooling and charging hardware in a battery-based FEV. Hybrid-electric vehicle (HEV) powertrains, in contrast, employ multiple sources of tractive power to propel the vehicle, most commonly operating an internal combustion engine assembly in conjunction with a battery-powered or fuel-can-powered traction motor. Since hybrid-type, electric-drive vehicles derive their power from sources other than the engine, HEV engines may be turned off, in whole or in part, while the vehicle is propelled by the electric motor(s).

High-voltage (HV) electrical systems govern the transfer of electricity between the traction motors and the rechargeable battery packs that supply the requisite power for operating many hybrid-electric and full-electric powertrains. To provide the power capacity and energy density needed to propel a vehicle at desired speeds for desired ranges, contemporary traction battery packs group multiple battery cans (e.g., 8-16+ cans/stack) into individual battery modules (e.g., 10-40+ modules/pack) that are electrically interconnected in series or parallel and mounted onto the vehicle chassis, e.g., by a battery pack housing or support tray. Located on a battery side of the HV electric system is a front-end DC-to-DC power converter that is electrically connected to the traction battery pack(s) to increase the supply of voltage to a main DC bus and a DC-to-AC power inverter module (PIM). A high-frequency bulk capacitor may be arranged across the positive and negative terminals of the main DC bus to provide electrical stability and store supplemental electrical energy. A dedicated Electronic Battery Control Module (EBCM), through collaborative operation with a Powertrain Control Module (PCM) and each motor's power electronics package, governs operation of the battery pack(s) and traction motor(s).

A battery array, such as a battery module, pack, etc., typically includes a plurality of battery cans located in relatively close proximity to one another. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Lithium-ion batteries age with both time and usage, resulting in reduced energy storage capability. The undesirable growth of a passive surface layer (Solid Electrolyte Interphase, SEI) on the anode creates resistance to lithium-ion flow, which results in a rise in the charge transfer resistance and the impedance of the anode. The SEI layer is made of decomposed compounds from the electrolyte that bind with the anode surface material (e.g., graphite). Some of these compounds include, but are not limited to, lithium carbonate, lithium alkyl, and lithium-fluorine compounds.

Graphite is one of the common anode materials for lithium-ion batteries operating in organic electrolytes, such as LiPF6, with co-solvents such as ethylene carbonate (EC), dimethyl carbonate (DMC), diethyl carbonate (DEC), methyl ethyl carbonate (EMC)). The reaction of the anode with the electrolyte solution results in the formation of species such as ROCO₂Li and CO₂OLi, on the anode surface. The layer formed by these species is referred to as a SEI layer. The ROCO₂Li can undergo reduction reactions with CO₂ and traces of H₂O in the electrolyte to form lithium carbonate, which further reacts with EC to form transesterification products such DMDOHC (dimethyl-2,5-dioxahexane carboxylate), (dimethyl-2,5-dioxahexane carboxylate), EMDOHC (ethyl methyl-2,5-dioxahexane carboxylate) and DECDOHC (diethyl methyl-2,5-dioxahexane carboxylate)

In addition, anion contaminates, such as F⁻ from HF and PF₅, readily react with lithium to form insoluble reaction products which are non-uniform, electronically insulating, and unstable on the surface of the graphite anode. In addition, the dissolution of the cathode electrode metal from the lattice into the electrolyte due to the disproportionation of Transition Metal (TM) ions, such as Mn³⁺ (into Mn²⁺ and Mn⁴⁺) by traces of hydrofluoric acid (HF) in the electrolyte, resulting in the deposition of cation contaminates, such as Mn, Co and Fe, on the anode electrode surface. The consequences of TM ion dissolution and subsequent deposition may include: (1) material loss and capacity fading at the positive electrode, and (2) deposition on the negative electrode (i.e., reduction) which, under certain conditions, may degrade the thin, initially-protective SEI layer, while also blocking (desirable) lithium intercalation of lithium ions into the negative electrode. Hence, TM dissolution may be an intrinsic challenge for lithium-ion batteries, especially for high-energy density Nickel Manganese Cobalt (NMC) lithium-ion batteries.

In lithium-based batteries, the SEI layer (also known as a passivation layer), is a layer of material that forms between the negative electrode and the liquid electrolyte. It is produced spontaneously by the breakdown of electrolyte compounds at the highly reducing potentials inherent to these systems. The SEI layer is an important element controlling the efficiency, safety, and lifetime of lithium batteries. A stable SEI layer may ensure good, long-term charge capacity retention stability, while an unstable (growing) SEI layer will ultimately consume lithium ions, thereby decreasing charge capacity while increasing internal charge transfer resistance. Hence, unstable SEI layer formation is one of the primary reasons for poor capacity retention of high-capacity electrodes, which typically have large volume change during charging and discharging processes.

What is needed, then, is a method of forming a polymeric separator membrane that mitigates: (1) battery capacity fading caused by acidic species (such as HF and other acid species in the electrolyte solution), and (2) the dissolution of transition metal ions from the battery's cathode.

### SUMMARY

A functionalized polymeric separator membrane, including a polymer backbone chosen from an aramid-based polymer, a polyamide-based polymer, or a polyimide-based polymer, or combinations thereof; and further comprising one or more functional side groups (-FSG) capable of trapping transition metal ions and acidic species. The functionalized polymeric separator membrane may be a sulfonated polyaramid separator membrane. Sulfonation of polyaramid separators add functional groups that trap both acidic species and TM ions, thereby suppressing anode damage caused by TM deposition onto the anode by a two-step process. The functionalized polymer separator membranes may be used with Li-ion, Li-metal, or Sodium-ion batteries.

The present disclosure also teaches processes to functionalize polyaramid, polyamide, or polyimide-based separator membranes for use with rechargeable batteries. During battery operation, the functional sulfonate groups will trap acid species from the electrolyte solution, as well as trapping transition metal ions that are dissolved from the cathode. The trapping of acid species will also reduce the amount of transition metal dissolution from the cathode, and the trapping of the Transition Metal (TM) ions will prevent their migration to, and their deposition onto the anode, thereby mitigating battery degradation.

Sulfonation of polyaramid separators adds functional groups that trap both acidic species and TM ions, thereby suppressing anode damage caused by TM deposition onto the anode by a two-step process. Amination of the aromatic backbone may also provide acid scavenging capability. Functionalization of the polyamide backbone may also provide acid scavenging capability. The functionalized polymer separator membranes may be used with Li-ion, Li-metal, or Sodium-ion batteries.

The functional groups disclosed herein provide two-step protection against the consequences of TM deposition at the anode, including: (1) reducing the amount of acid species in the electrolyte solution (and, consequently, reducing the amount of TM ions dissolved from the cathode by acid-scavenging chemical moieties); (2) trapping in the separator membrane those TM ions that still dissolve from the cathode, and (3) preventing the TM ions from reaching the anode. There are two defense mechanisms at play: (1) acid scavenging, which addresses the root cause of the DMDCR (Dissolution from cathode—Migration through electrolyte solution—Deposition at anode—Catalytic electrolyte solution decomposition Reactions at anode) degradation mechanism, by preventing dissolution altogether (hence, interference with the first “D”); and (2) trapping of TM ions that manage to be removed from the cathode (hence, interference with the second “D”).

In some embodiments, a functionalized polymeric separator membrane includes a polymer backbone chosen from an aramid-based polymer chain, a polyamide-based polymer chain, or a polyimide-based polymer chain, or combinations thereof; and further including one or more functional side groups, wherein the one or more functional side groups are capable of trapping transition metal ions and acidic species.

In some embodiments, a functionalized polyaramid separator membrane includes a polyaramid polymer backbone defined by two benzene rings joined by a carboxamide group (—C(═O)NH₂).

In some embodiments, the functionalized polyaramid separator membrane may include a urethane derivative side group.

In some embodiments, the functionalized polyaramid separator membrane may include a urea derivative side group.

In some embodiments, the functionalized polymeric separator membrane includes one or more functional side groups chosen from: (a) Sulfhydryl groups (—SH); (b) Carboxylate groups (—COO—); (c) Amino groups (—NH₂); (d) Hydroxyl groups (—OH); or (e) Pyridine groups (—C₅NH₄); or combinations thereof.

In some embodiments, a functionalized polyaramid separator membrane includes a polyaramid polymer backbone defined by two benzene rings joined by a carboxamide group (—C(═O)NH₂); and further including one or more metal-trapping side groups (-M) capable of trapping transition metal ions; and further including one or more acid-trapping side groups (-A) capable of trapping acidic species.

In some embodiments, the one or more metal-trapping side groups (-M) may include —SO₃Li.

In some embodiments, the one or more acid-trapping side groups (-A) may include amine groups, (—NH₂).

In some embodiments, the one or more acid-trapping side groups (-A) may include amide derivatives.

In some embodiments, the one or more acid-trapping side groups (-A) may include urea derivatives.

In some embodiments, the acid-trapping side groups may include EDTA acid-trapping groups made by treating the polyaramid separator membrane with EDTA anhydrides.

In some embodiments, the functionalized polyaramid separator membrane includes: one or more nitrogen atoms and one or more acid-trapping functional groups attached to the one or more nitrogen atoms; wherein the one or more acid-trapping functional groups comprise an isocyanate linkage having an amine group, —NH₂, substituted for O══C══N on a diisocyanate linkage.

In some embodiments, a method of forming a functionalized polymer separator membrane includes: firstly, contacting a solution containing functional side groups with a precursor polymer separator membrane to form a functionalized polymer separator membrane; secondly, rinsing the functionalized polymer separator membrane in deionized water or a basic solution to form a workpiece; and thirdly, drying the workpiece in an oven to thoroughly remove adsorbed water; thereby forming the functionalized polymer separator membrane with functional side groups.

In some embodiments, the polymer separator membrane may be a polyaramid separator membrane.

In some embodiments, the solution may be at least one of sulfuric acid, chlorosulfonic acid, or sulfamic acid, or combinations thereof; and the method further includes contacting diluted LiOH or lithium sulfate with the functionalized polyaramid separator membrane to form a workpiece; before rinsing the functionalized polyaramid separator membrane in deionized water.

In some embodiments, the solution may be a nitration solution, and secondly, subjecting the nitrated polyaramid separator membrane to a reduction bath to form a reduced workpiece; thirdly, contacting the reduced workpiece with deionized water; and fourthly, drying the reduced workpiece in an oven to thoroughly remove adsorbed water; thereby forming the nitrated polyaramid separator membrane.

In some embodiments, the nitration solution may be a mixture of nitric acid (HNO₃) and sulfuric acid (H₂SO₄); and wherein the reduction bath may be sodium dithionate, NaS₂O₄.

In some embodiments, the solution may be a mixture of Diisocyanate and 1,4-diazabicyclo[2.2.2]octane (DABCO).

In some embodiments, the method may include replacing the deionized water with a first solution including alcohols that form urethane derivative side groups, or a second solution including amines that form urea derivative side groups.

In some embodiments, the solution may include an activated thiol-reactive agent; wherein the activated thiol-reactive agent may include a thiol-reactive agent mixed with a solvent comprising water or dimethyl sulfoxide; and secondly, combining the activated thiol-reactive agent with a polyaramid solution to form a functionalized polyaramid separator membrane that is functionalized with —SH groups.

In some embodiments, the thiol-reactive agent may be 2-iminothiolane, N-succinimidyl 3-(2-pyridyldithio)propionate.

In some embodiments, the solution may include a carboxylate precursor; thereby forming a functionalized polyaramid separator membrane having —COO— side groups.

In some embodiments, the carboxylate precursor may be chosen from carboxylic acid, a carboxylate-containing compound, acetic acid (CH₃COOH), or succinic anhydride (C₄H₄O₃), or combinations thereof.

### BRIEF DESCRIPTION OF THE DRAWINGS

FIG. 1 shows a schematic, cross-section view of an example of a lithium-ion battery stack, according to the present disclosure.

FIG. 2A shows a chemical structure of an example of a polyaramid backbone (meta-aramid) of a separator membrane, according to the present disclosure.

FIG. 2B shows a chemical structure of an example of a modified polyaramid backbone (meta-aramid) after being sulfonated with —SO₃H groups, according to the present disclosure.

FIG. 2C shows a chemical structure of an example of a modified polyaramid backbone (meta-aramid), after undergoing lithium-ion exchange, according to the present disclosure.

FIG. 2D shows a chemical structure of an example of a modified polyaramid backbone (meta-aramid), after trapping transition metal manganese ions, according to the present disclosure.

FIG. 3 is a graphical representation of a relationship of the optical transmissivity of a treated (modified) polyaramid separator membrane as a function of wavenumbers, compared to an untreated polyaramid material, according to the present disclosure.

FIG. 4A shows a chemical structure of an example of a polyaramid backbone (meta-aramid), according to the present disclosure.

FIG. 4B shows a chemical structure of an example of a modified polyaramid backbone (meta-aramid), after treatment with a mixture of HNO₃ and H₂SO₄, according to the present disclosure.

FIG. 4C shows a chemical structure of an example of a modified polyaramid backbone (meta-aramid), after treatment with NaS₂O₄, according to the present disclosure.

FIG. 5A shows a chemical structure of an example of a polyaramid backbone (meta-aramid), according to the present disclosure.

FIG. 5B shows a chemical structure of an example of a modified polyaramid backbone (meta-aramid), after treatment with a mixture of DABCO (1,4-diazabicyclo[2.2.2]octane) and Diisocyanate, according to the present disclosure.

FIG. 5C shows a chemical structure of an example of a modified polyaramid backbone (meta-aramid), after final treatment with H₂O, according to the present disclosure.

FIG. 5D shows a chemical structure of an example of a Diisocyanate linkage, where R=an alkyl group, an aromatic group, or a nonreactive group, according to the present disclosure.

FIG. 6 shows a chemical structure of an example of a modified polyaramid backbone (meta-aramid), with amide derivative acid-trapping side groups, wherein R′=an alkyl group, an aromatic group, or a nonreactive group, according to the present disclosure.

FIG. 7 shows a chemical structure of an example of a modified polyaramid backbone (meta-aramid), with urea derivative acid-trapping side groups, wherein R′=an alkyl group, an aromatic group, or a nonreactive group, according to the present disclosure.

FIG. 8 shows a chemical structure of an example of a modified polyaramid backbone (meta-aramid), with EDTA acid-trapping side groups made by treating the polymeric separator membrane with EDTA anhydride, according to the present disclosure.

FIG. 9 shows a chemical structure of an example of a modified polyaramid backbone (meta-aramid), with urethane derivative acid-trapping side groups, wherein R=an alkyl group, an aromatic group, or a nonreactive group, according to the present disclosure.

FIG. 10 shows a chemical structure of an example of a modified polyaramid backbone (meta-aramid), with urea derivative acid-trapping side groups, wherein R=an alkyl group, an aromatic group, or a nonreactive group, according to the present disclosure.

FIG. 11 shows a chemical structure of an example of a modified polyaramid backbone (meta-aramid), with hydroxyl (—OH) functional side groups, according to the present disclosure.

FIG. 12 shows a chemical structure of an example of a modified polyaramid backbone (meta-aramid), with Sulfhydryl (—SH) functional side groups, according to the present disclosure.

FIG. 13 shows a chemical structure of an example of a modified polyaramid backbone (meta-aramid), with Carboxylate (—COO—) functional side groups, according to the present disclosure.

FIG. 14 shows a chemical structure of an example of a modified polyaramid backbone (meta-aramid), with Lithiated Carboxylate (—COOLi) functional side groups, according to the present disclosure.

FIG. 15 shows a chemical structure of an example of a modified polyaramid backbone (meta-aramid), with pyridine (—C₅NH₄) functional side groups, according to the present disclosure.

FIG. 16 shows an example of a block diagram for forming a functionalized polyaramid separator membrane, according to the present disclosure.

FIG. 17 shows an example of a block diagram for forming a sulfonated polyaramid separator membrane, according to the present disclosure.

FIG. 18 shows an example of a block diagram for forming a nitrated polyaramid separator membrane, according to the present disclosure.

FIG. 19 shows an example of a block diagram for forming a modified polyaramid separator membrane with aminated diisocyanate side groups, according to the present disclosure.

FIG. 20 shows an example of a block diagram for forming a functionalized polyaramid separator membrane with —SH side groups, according to the present disclosure.

FIG. 21 shows an example of a block diagram for forming a functionalized polyaramid separator membrane with —COO— groups, according to the present disclosure.

FIG. 22 shows a chemical structure of an example of a polyaramid backbone (meta-aramid) of a separator membrane with metal-trapping side groups (-M) and acid-trapping side groups (-A), according to the present disclosure.

FIG. 23 shows a chemical structure of an example of a polyaramid backbone (meta-aramid) of a separator membrane with functional side groups (-FSG), according to the present disclosure.

FIG. 24 shows a schematic, perspective view of an example of an electric vehicle, according to the present disclosure.

### DETAILED DESCRIPTION

This disclosure is capable of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or logical combination thereof, for example.

Unless specifically stated from context, as used herein, the term “about” is understood as within a range of normal tolerance in the art, for example within 2 standard deviations of the mean. “About” may be understood as within 10%, 5%, 1%, 0 5%, 0.1%, 0.05%, or 0.01% of the stated value. “About” can alternatively be understood as implying the exact value stated. Unless otherwise clear from the context, the numerical values provided herein are modified by the term “about.”

Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

The terms “separator” and “separator membrane” are used interchangeably herein. The terms “treated” and “modified” are used interchangeably herein. The phrases “polymer backbone” and “polyaramid backbone” mean a polymeric chain of connected, repeating subunits.

The present separator membranes may be used with a variety of different battery chemistries, including, but not limited to, Li-ion, Li-metal, and Sodium-ion battery chemistries.

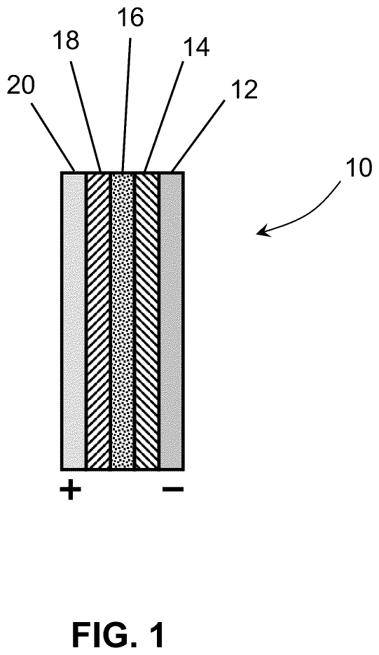

FIG. 1 illustrates a schematic, cross-section view of an example of a Lithium-ion battery stack 10. The five stacked battery layers of Lithium-ion battery stack 10 include: a negative current collector layer 12; a negative electrode layer 14 disposed adjacent to the negative current collector layer 12; a porous separator layer 16 disposed adjacent to the negative electrode layer 14; a positive electrode layer 18 disposed adjacent to the porous separator layer 16 opposite the negative electrode layer 14; and a positive current collector layer 20 disposed adjacent to the positive electrode layer 18. The negative current collector layer 12 may comprise a copper sheet. The negative electrode layer 14 may comprise a material chosen from: lithium, graphite, Lithium Titanate, Silicon/Carbon, or Tin/Cobalt alloy, or combinations thereof. The porous separator layer 16 may comprise a micro-porous polymer chosen from: micro-porous polyethylene (PE), micro-porous polypropylene (PP), micro-porous polyethylene terephthalate (PET), micro-porous polyaramid (PA), or ceramic coating on one side or two sides of a micro-porous polymer membrane, or combinations thereof. The ceramic coating material may include: aluminum oxide, silicon oxide, titanium oxide, boehmite, magnesium oxide, zeolite, lithiated zeolite, or combinations thereof. The positive electrode layer 18 may comprise a compound chosen from: lithium-metal-oxides, LiCoO₂ (LCO), LiMn₂O₄ (LMO), LiFePO₄ (LFP), Nickel-Manganese-Cobalt oxides (NMC), or Nickel-Cobalt-Aluminum Oxide (NCA), or combinations thereof. Finally, in some embodiments, the positive current collector layer 20 may comprise aluminum. The five stacked battery layers may be contained within a sealed, prismatic or cylindrical battery can (i.e., housing), with positive and negative tabs that protrude from the top of the can.

The aromatic polyaramid separator membranes described herein are highly porous materials (e.g., micro-porous and nano-porous membranes).

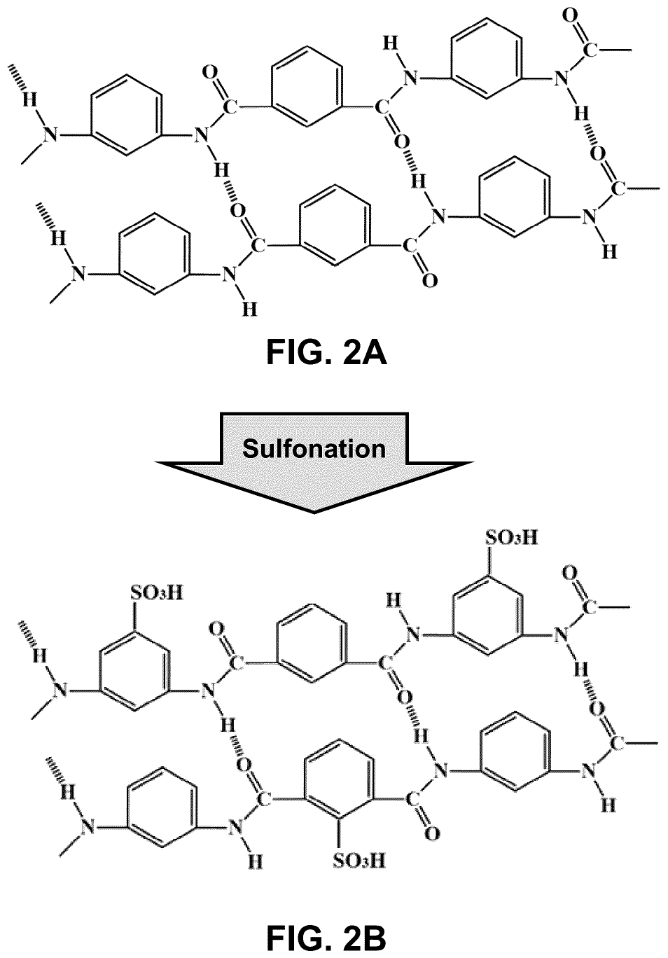

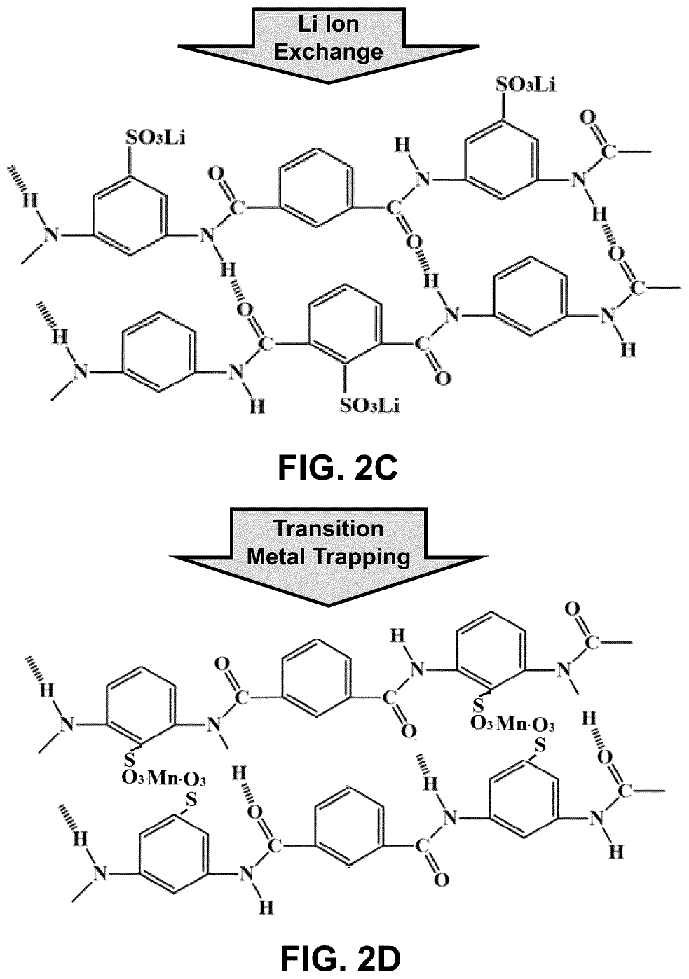

FIG. 2A shows a chemical structure of an example of a precursor polyaramid backbone (e.g., meta-aramid), according to the present disclosure. Polyaramid polymers are named as polyparaphenylene terephthalamide or polymetaphenylene terephthalamide. In some embodiments, para-aramid polymers may be used in place of meta-aramid polymers. In some embodiments, combinations of both meta-aramid and para-aramid polymers may be used together. The precursor polyaramid backbone chain comprises repeating units comprising two benzene rings joined by carboxamide groups (—C(═O)NH₂). The two benzene rings are alternatively attached to two NH groups or two CO groups. The word “polyaramid” is short for “aromatic polyaramid”.

FIG. 2B shows a chemical structure of an example of a modified polyaramid backbone (meta-aramid) after being sulfonated with —SO₃H groups, according to the present disclosure. Sulfonation of aramid polymers involves the substitution of protons on the polyaramid backbone with sulfonic acid groups (—SO₃H) by treating with sulfuric acid, H₂SO₄. Sulfonated polyaramids trap transition metals (e.g., manganese) due to the presence of sulfonic acid groups (which have a high affinity for metal ions). The sulfonation process may comprise immersing or passing diluted and heated sulfuric acid (e.g., heated to about 70° C. to 90° C.) through the polyaramid separator membrane of FIG. 2A. The concentration of sulfuric acid may be from about 5 parts by weight to about 30 parts by weight, based on 100 parts by weight of an aqueous sulfuric acid solution.

FIG. 2C shows a chemical structure of an example of a modified polyaramid backbone (meta-aramid), after undergoing lithium-ion exchange, according to the present disclosure. Lithium-ion exchange may comprise immersing or passing diluted and heated LiOH (e.g., heated to about 70° C. to 90° C.) through the modified polyaramid separator membrane of FIG. 2B.

FIG. 2D shows a chemical structure of an example of a modified polyaramid backbone (meta-aramid), after trapping of transition metal manganese ions during battery use and recharging, according to the present disclosure. Manganese preferably displaces lithium ions in the —SO₃Li functional group in this step (which also happens for other transition metal ions (e.g., cobalt and iron).

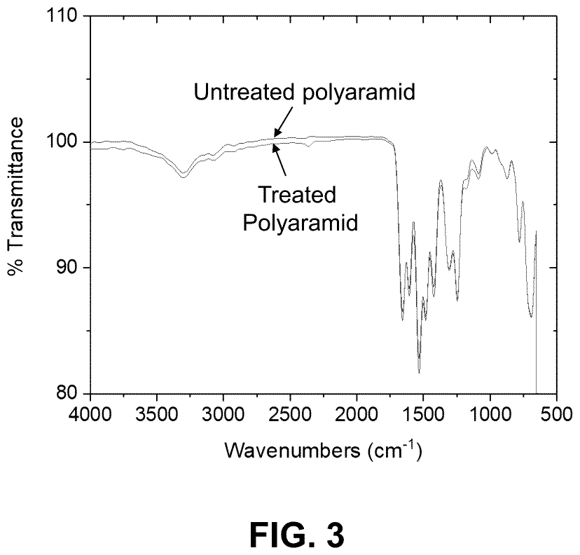

FIG. 3 shows a graphical representation of measurements of the optical transmissivity of a treated (modified) polyaramid material as a function of photon wavenumbers, compared to an untreated polyaramid material, according to the present disclosure. There is essentially no difference between the untreated and modified polyaramid materials, indicating that the sulfonation treatment of the polyaramid material has not damaged the modified polyaramid's structural properties.

Table 1 summarizes experimental measurements of the amount (concentration) of manganese and sulfur adsorption in three different types of modified Separator Membranes. The samples are first exposed to an excess amount of 0.1 M manganese salts for 10 minutes according to test standard “GLI Procedure ME-70”, and then the amount (concentration) of Mn or S that is adsorbed by the sample of separator membrane is measured with an inductively coupled plasma mass spectrometer system (ICP-MS). Sample #1 (Modified LG Chem Alumina-coated polyethylene (PE) separator) had very low measured concentrations of adsorbed manganese of 0.842% and Sulfur of <0.029%. This is because Sample #1 is not sulfonated. Sample #2 (Modified Sulfonated Polyaramid Separator) had much higher measured concentrations of adsorbed manganese of 2.47% and low adsorbed Sulfur of only 0.408%. Sample #3 (Modified Sulfonated Polyaramid Separator coated with Li-zeolite) has similar high measured concentrations of adsorbed manganese of 2.77% and lower adsorbed Sulfur of 0.293%. These results demonstrate that significant amounts of adsorption of the transition metal element, manganese, can occur as the result of sulfonating a polyaramid separator membrane.

TABLE 1
Manganese and Sulfur Adsorption in Sulfonated
Polyamide Separator Membranes

| Analysis | Concentration | Sample Amount | Sample Description |
|---|---|---|---|
| Sample #1 | | | Modified LG Chem |
| | | | Alumina Coated PE |
| | | | Separator |
| Manganese | 0.842% | 17.70 mg | |
| Sulfur | <0.029% | 17.70 mg | |
| Sample #2 | | | Modified Polyaramid |
| | | | Separator |
| Manganese | 2.47% | 5.585 mg | |
| Sulfur | 0.408% | 5.585 mg | |
| Sample #3 | | | Modified Polyaramid |
| | | | Separator Coated |
| | | | with Li-Zeolite |
| Manganese | 2.77% | 6.281 mg | |
| Sulfur | 0.293% | 6.281 mg | |

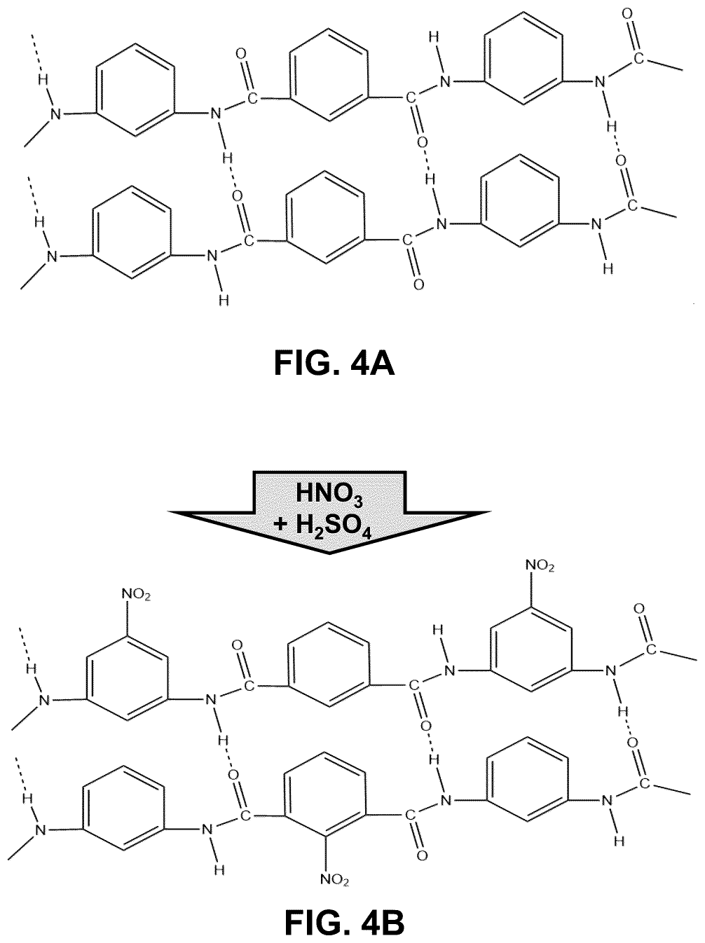

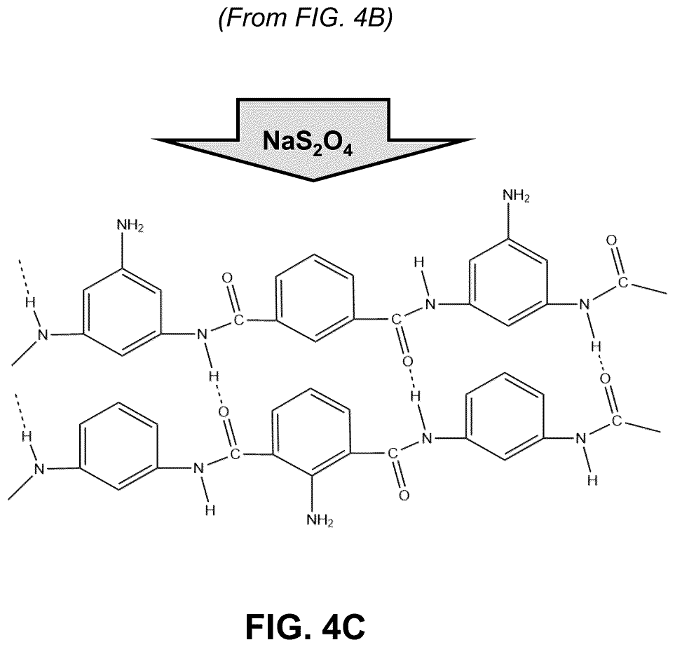

FIG. 4A shows a chemical structure of an example of a precursor polyaramid backbone (meta-aramid), according to the present disclosure.

FIG. 4B shows a chemical structure of an example of a modified polyaramid backbone (meta-aramid), after a nitration treatment with a solution comprising nitric acid (HNO₃), or a mixture of nitric acid and sulfuric acid (H₂SO₄), according to the present disclosure. The relative proportions of nitric acid and sulfuric acid in the nitration solution may be 1:1. In some embodiments, concentrated nitric acid may be used alone. In some embodiments, acyl nitrates may be used. This nitration treatment replaces the proton on a benzene ring with a —NO₂ group.

FIG. 4C shows a chemical structure of an example of a modified polyaramid backbone (meta-aramid), after treatment with a reduction agent (e.g., sodium diathionate, NaS₂O₄), according to the present disclosure. This step replaces the —NO₂ group from FIG. 4B with an amine group, —NH₂, which provides enhanced acid scavenging functionality.

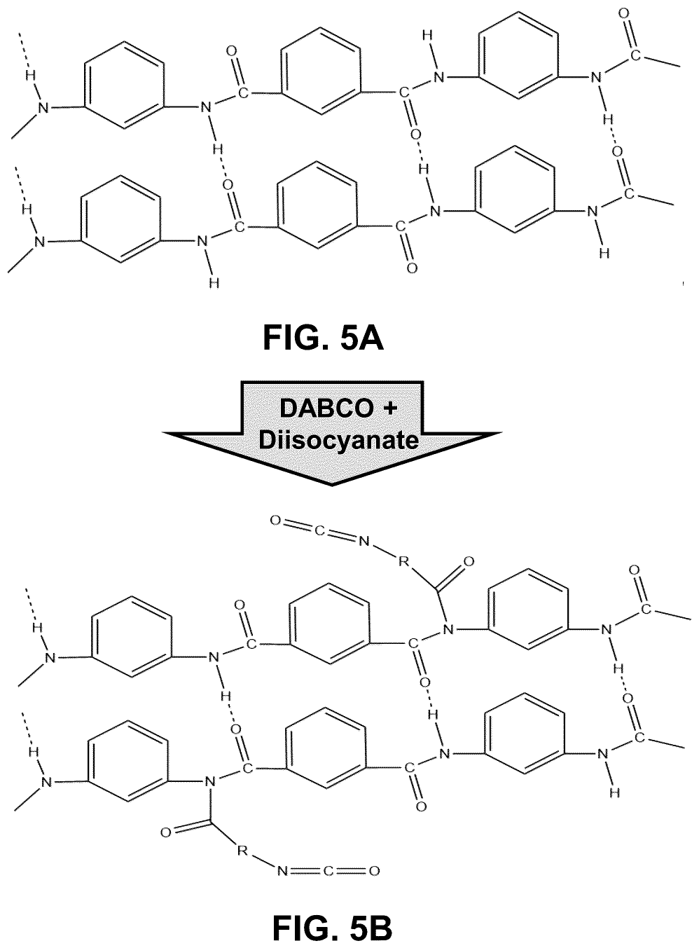

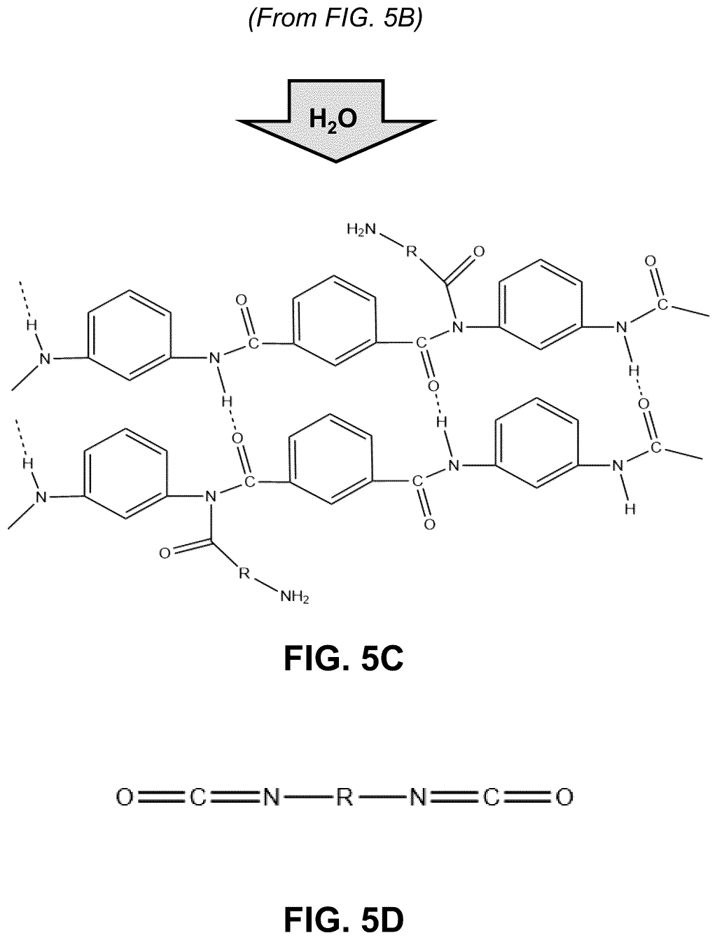

FIG. 5A shows a chemical structure of an example of a precursor polyaramid backbone (meta-aramid), according to the present disclosure.

FIG. 5B shows a chemical structure of an example of a modified polyaramid backbone (meta-aramid), after functionalization treatment with a mixture of DABCO (1,4-diazabicyclo[2.2.2]octane) and Diisocyanate according to the present disclosure. They are used in a molar ratio of 1 DABCO to 100 Diisocyanate, with a range from 1:20 to 1:200. Isocyanate is a functional group with the formula —R—N═C═O. Diisocyante is generally defined as: OCN—R—OCN. Examples of suitable diisocyanates include: (NCO)₂ and Hexamethylene Diisocyanate (CH₂)₆(NCO)₂.

FIG. 5C shows a chemical structure of an example of a modified polyaramid backbone (meta-aramid), after treatment with H₂O of the functionalized separator membrane from FIG. 5B, according to the present disclosure.

FIG. 5D shows a chemical structure of an example of a Diisocyanate linkage, where R=an alkyl group, an aromatic group, or a nonreactive group, according to the present disclosure. The Diisocyanate linkage is defined by:

O═C═N—R—N═C═O

where R=an alkyl group, an aromatic group, or a nonreactive group, according to the present disclosure. Common examples of R may include: Ethyl, Propyl, Hexyl, Benzyl, Toluene, and Cyclohexyl. In other embodiments, R may include: Alkyl (Hexamethylene Diisocyanate), Aromatic (1,3-Diisocyanatobenzene), or cycle (Isophorone Diisocyanate), or combinations thereof.

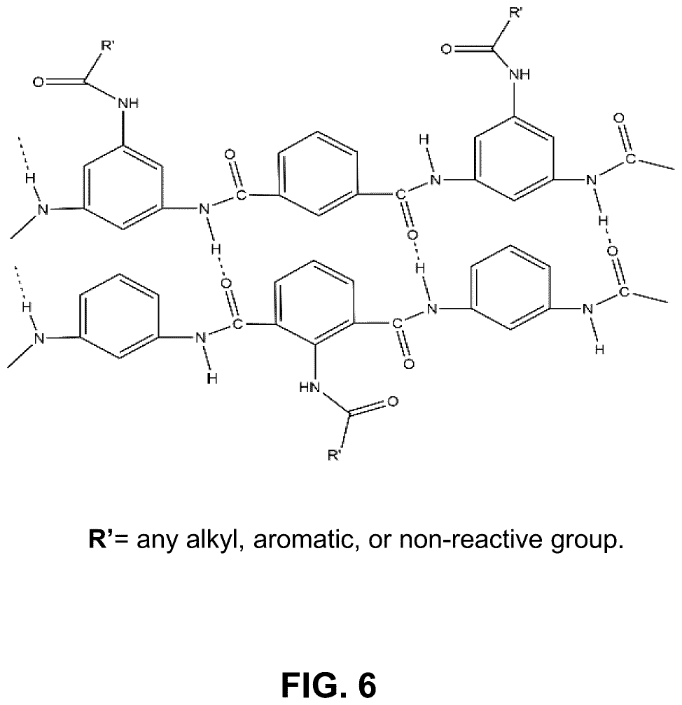

FIG. 6 shows a chemical structure of an example of a modified polyaramid backbone (meta-aramid), with amide derivative acid-trapping side groups, wherein R′=an alkyl group, an aromatic group, or a nonreactive group, according to the present disclosure.

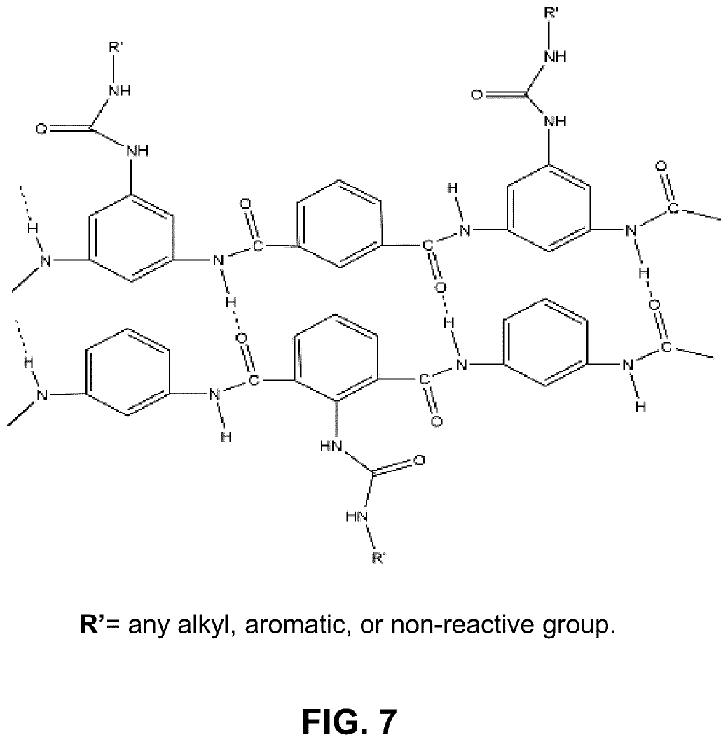

FIG. 7 shows a chemical structure of an example of a modified polyaramid backbone (meta-aramid), with urea derivative acid-trapping side groups, wherein R′=an alkyl group, an aromatic group, or a nonreactive group, according to the present disclosure.

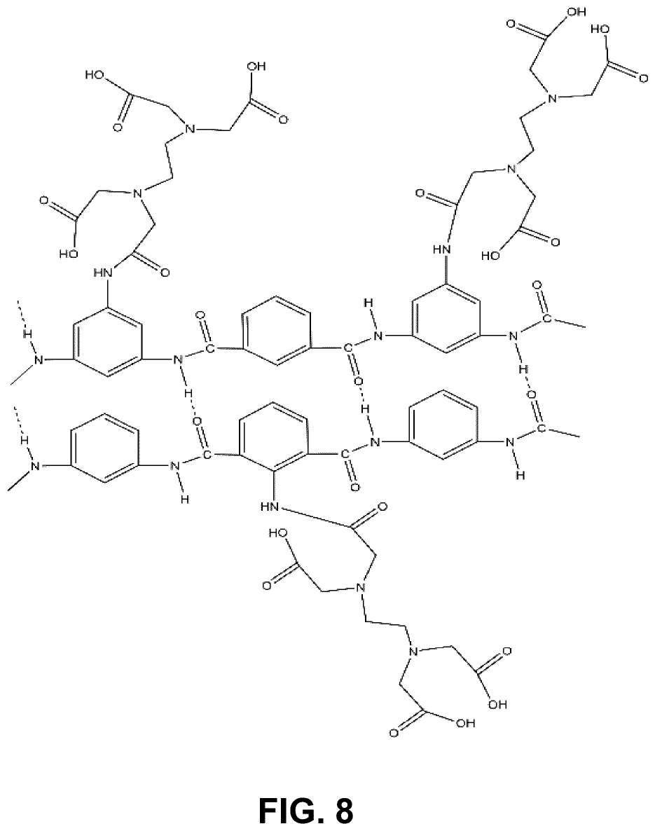

FIG. 8 shows a chemical structure of an example of a modified polyaramid backbone (meta-aramid), with EDTA acid-trapping side groups made by treating the polymeric separator membrane with EDTA anhydrides, according to the present disclosure. EDTA stands for ethylenediaminetetraacetic acid (C₁₀H₁₆N₂O₈), and is a metal chelation agent which binds to metal ions, including Mn²⁺. In some embodiments, other compounds may be used to treat the polymer separator membrane, including: acid chlorides, anhydrides, or isocyanates, or combinations thereof.

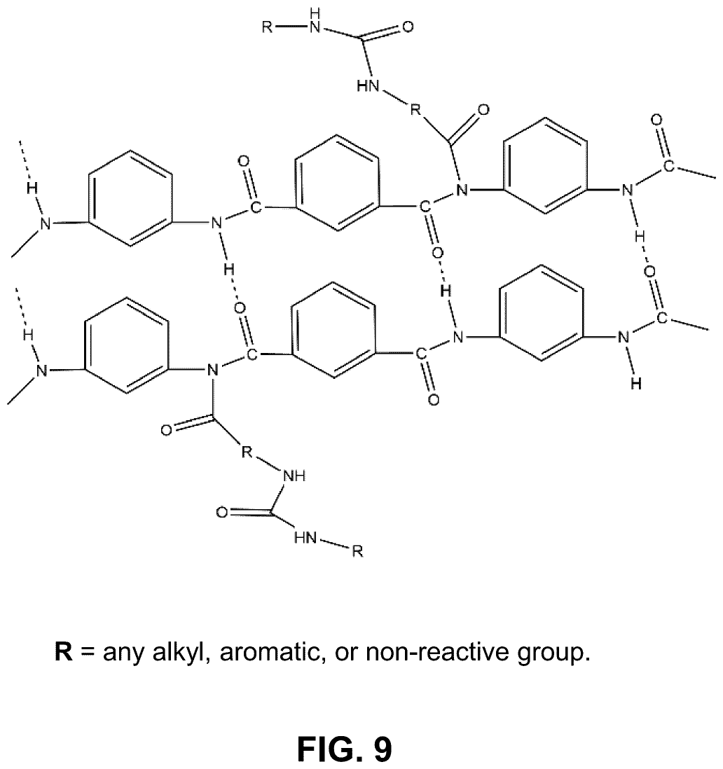

FIG. 9 shows a chemical structure of an example of a modified polyaramid backbone (meta-aramid), with urethane derivative acid-trapping side groups, wherein R=an alkyl group, an aromatic group, or a nonreactive group, according to the present disclosure.

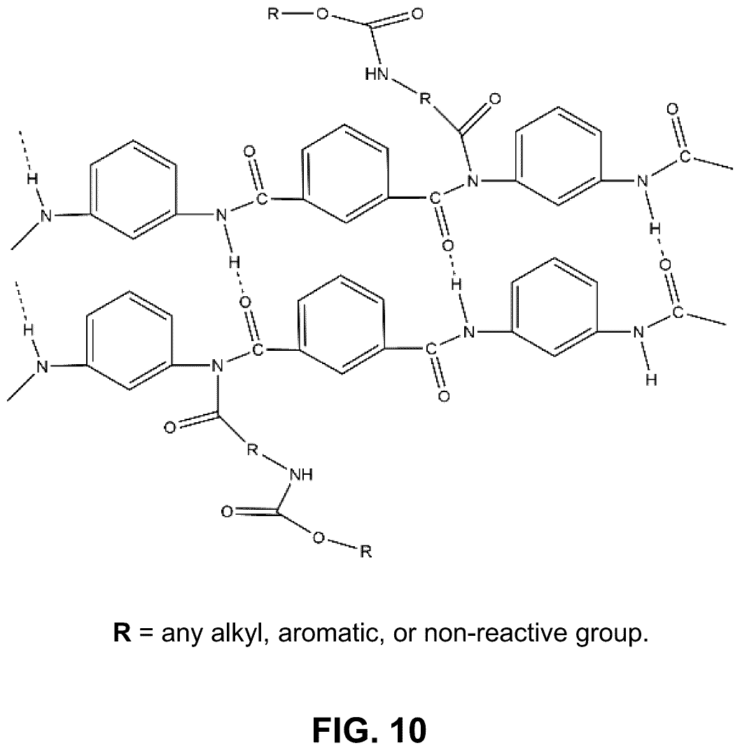

FIG. 10 shows a chemical structure of an example of a modified polyaramid backbone (meta-aramid), with urea derivative acid-trapping side groups, wherein R=an alkyl group, an aromatic group, or a nonreactive group, according to the present disclosure.

In some embodiments, the following polymer separator membranes may be functionalized according to the techniques presented above, including, but not limited to: (a) aramid-based separator membranes (e.g., meta-aramid, para-aramid); (b) polyimide-based separator membranes, and (c) polyamide-based separator membranes.

In some embodiments, the following functional groups may be added to the polymer backbone of the separator membrane, which may trap acidic species and/or transition metal ions:
1. Sulfhydryl groups (—SH);
2. Carboxylate groups (—COO—);
3. Amino groups (—NH₂);
4. Hydroxyl groups (—OH); and
5. Pyridine groups (—C₅NH₄).

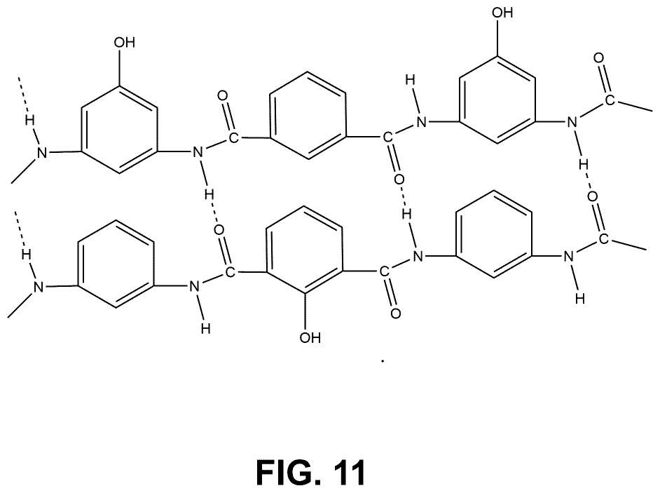

FIG. 11 shows a chemical structure of an example of a modified polyaramid backbone (meta-aramid), with hydroxyl (—OH) functional side groups, according to the present disclosure.

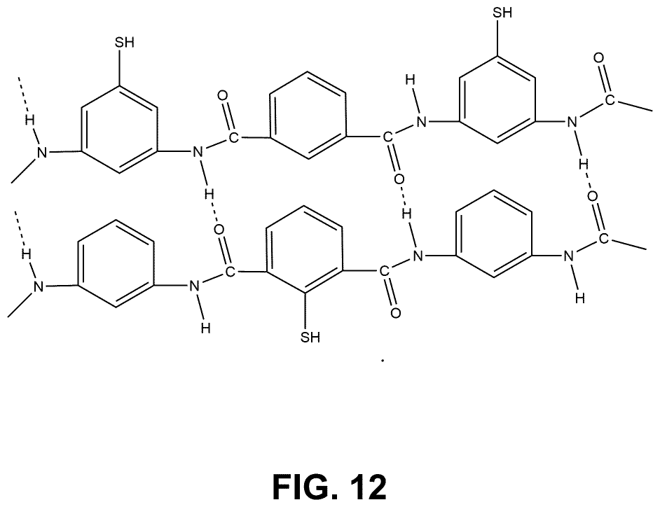

FIG. 12 shows a chemical structure of an example of a modified polyaramid backbone (meta-aramid), with Sulfhydryl (—SH) functional side groups, according to the present disclosure.

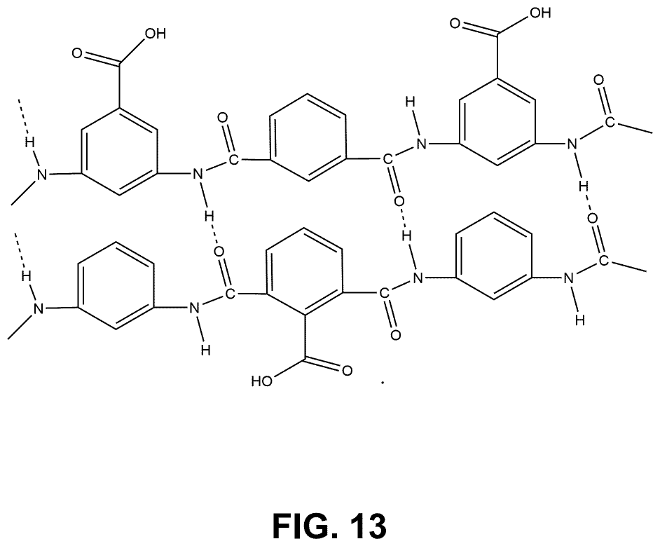

FIG. 13 shows a chemical structure of an example of a modified polyaramid backbone (meta-aramid), with Carboxylate (—COO—) functional side groups, according to the present disclosure.

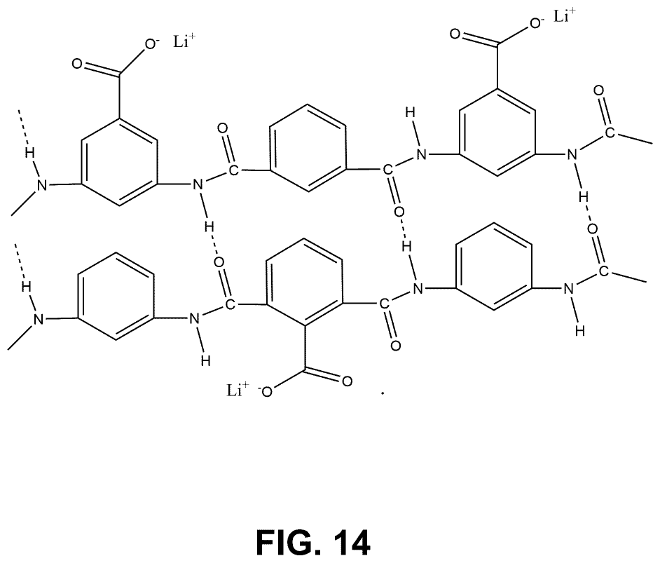

FIG. 14 shows a chemical structure of an example of a modified polyaramid backbone (meta-aramid), with Lithiated Carboxylate (—COOLi) functional side groups, according to the present disclosure.

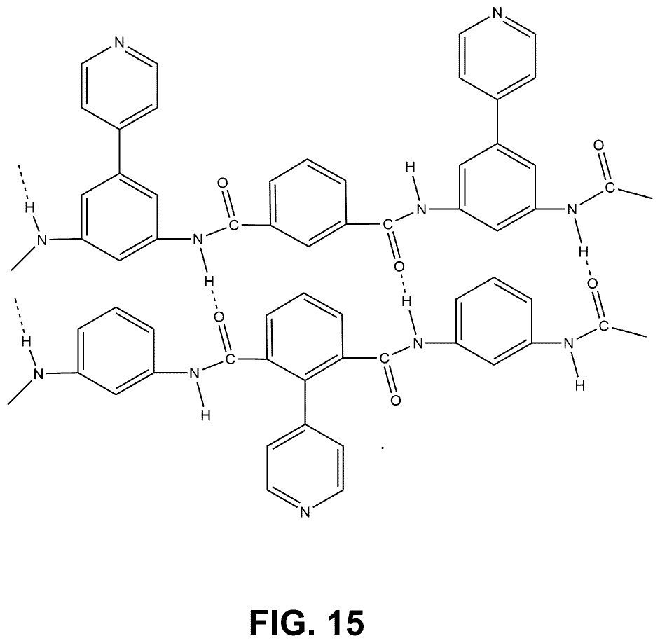

FIG. 15 shows a chemical structure of an example of a modified polyaramid backbone (meta-aramid), with pyridine (—C₅NH₄) functional side groups, according to the present disclosure.

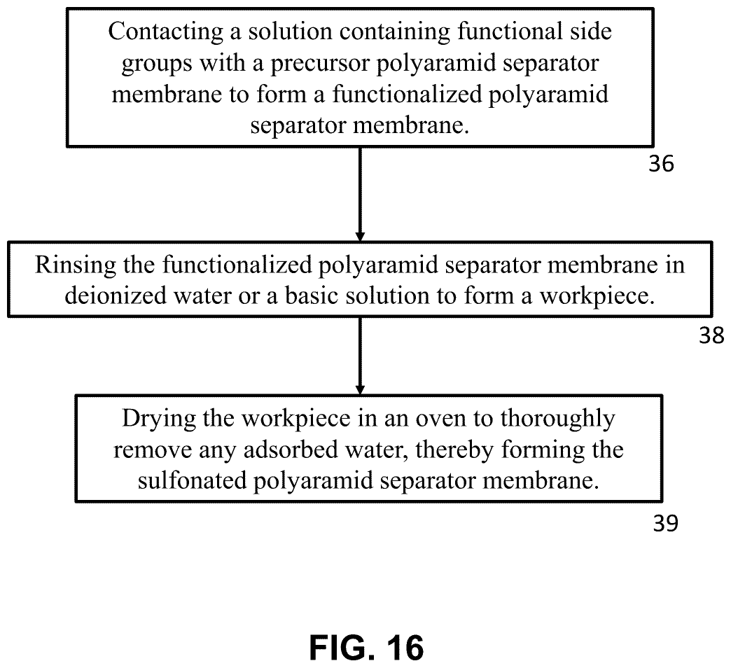

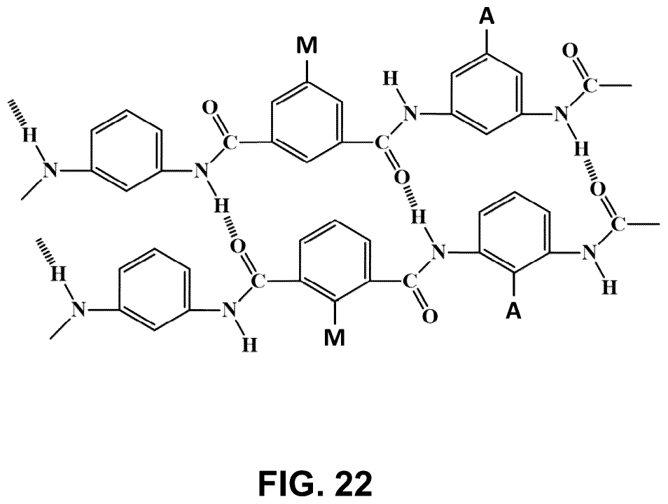

FIG. 16 shows an example of a block diagram for functionalizing a polyaramid separator membrane (as illustrated in FIG. 22), according to the present disclosure. The method comprises:
(1) contacting a solution containing functional side groups with a precursor polyaramid separator membrane to form a functionalized polyaramid separator membrane (Step 36);
(2) rinsing the functionalized polyaramid separator membrane in deionized water or a basic solution to form a workpiece (Step 38); and
(3) drying the workpiece in an oven to thoroughly remove adsorbed water, thereby forming the sulfonated polyaramid separator membrane (Step 39).

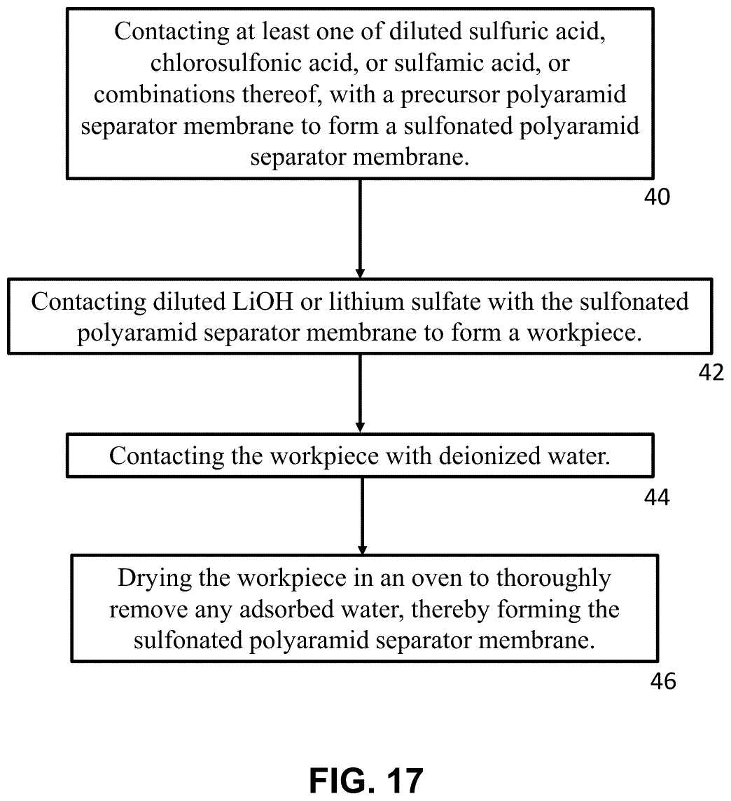

FIG. 17 shows an example of a block diagram for sulfonating a precursor polyaramid separator membrane (as illustrated in FIGS. 2A-2D), which includes:
(1) contacting at least one of diluted sulfuric acid, chlorosulfonic acid, or sulfamic acid, or combinations thereof, with a precursor polyaramid separator membrane to form a sulfonated polyaramid separator membrane (Step 40);
(2) contacting diluted LiOH or lithium sulfate with the sulfonated polyaramid separator membrane to form a workpiece (Step 42);
(3) contacting the workpiece with deionized water (Step 44); and
(4) drying the workpiece in an oven to thoroughly remove adsorbed water, thereby forming the sulfonated polyaramid separator membrane (Step 46). Step 40 may comprise diluting and heating the sulfuric acid, chlorosulfonic acid, or sulfamic acid to about 70° C. to 90° C. Step 44 may comprise washing away excess salt, lithium hydroxide, or lithium sulfate. Step 46 may comprise drying the workpiece in a vacuum oven at about 150 □C to thoroughly remove adsorbed water. Drying at longer times and lower temperatures (e.g., >100° C.) may also be used.

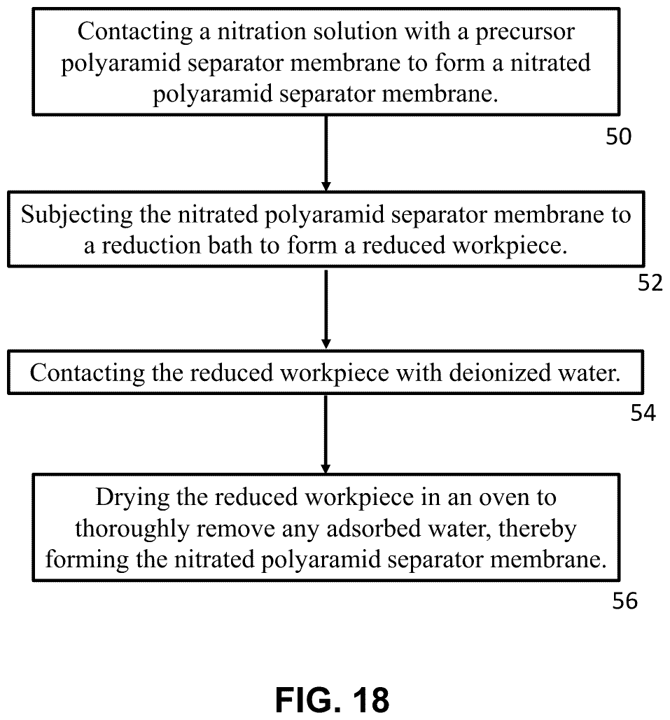

FIG. 18 shows an example of a block diagram for nitrating a precursor polyaramid separator membrane (as illustrated in FIGS. 4A-4C), which includes:
(1) contacting a nitration solution with a precursor polyaramid separator membrane to form a nitrated polyaramid separator membrane (Step 50);
(2) subjecting the nitrated polyaramid separator membrane to a reduction bath to form a reduced workpiece (Step 52);
(3) contacting the reduced workpiece with deionized water (Step 54); and
(4) drying the reduced workpiece in an oven to thoroughly remove adsorbed water, thereby forming the nitrated polyaramid separator membrane (Step 56). In some embodiments, the nitration solution may comprise a mixture of nitric acid and sulfuric acid. The reduction bath may comprise sodium dithionate. In some embodiments, further reactions with acid chlorides, anhydrides, or isocyanates may be used to add additional functionalization(s) of the polyaramid separator membranes. For example, EDTA anhydride (a common multidentate chelating agent) may be used for capturing metal ions, as discussed below.

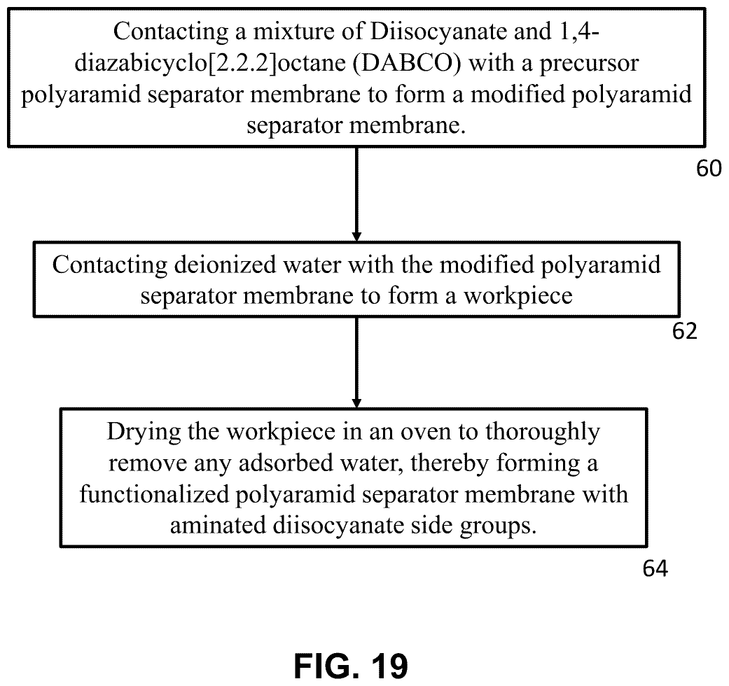

FIG. 19 shows an example of a block diagram for sulfonating a precursor polyaramid separator membrane (as illustrated in FIGS. 5A-5D), which includes:
(1) contacting a mixture of Diisocyanate and 1,4-diazabicyclo[2.2.2]octane (DABCO) with a precursor polyaramid separator membrane to form a modified polyaramid separator membrane (Step 60);
(2) contacting deionized water with the modified polyaramid separator membrane to form an aminated workpiece (Step 62); and
(3) drying the aminated workpiece in an oven to thoroughly remove adsorbed water, thereby forming a functionalized polyaramid separator membrane with aminated diisocyanate side groups (Step 64). Step 62 makes amine groups, —R—N—H₂, wherein R=an alkyl group, an aromatic group, or a nonreactive group. In some embodiments, step 62 may alternatively comprise, in place of contacting with deionized water, exposing the modified polyaramid separator membrane to a solution comprising alcohols (i.e., to make urethane derivatives), or a solution of amines (i.e., to make urea derivatives), or combinations thereof. The presence of amine groups, in general, provides acid scavenging.

In some embodiments, additional intermediate isocyanate treatment may be used to add a variety of functional side groups using isocyanate chemistry, via the formation, for example, of urethane linkages and/or ureas.

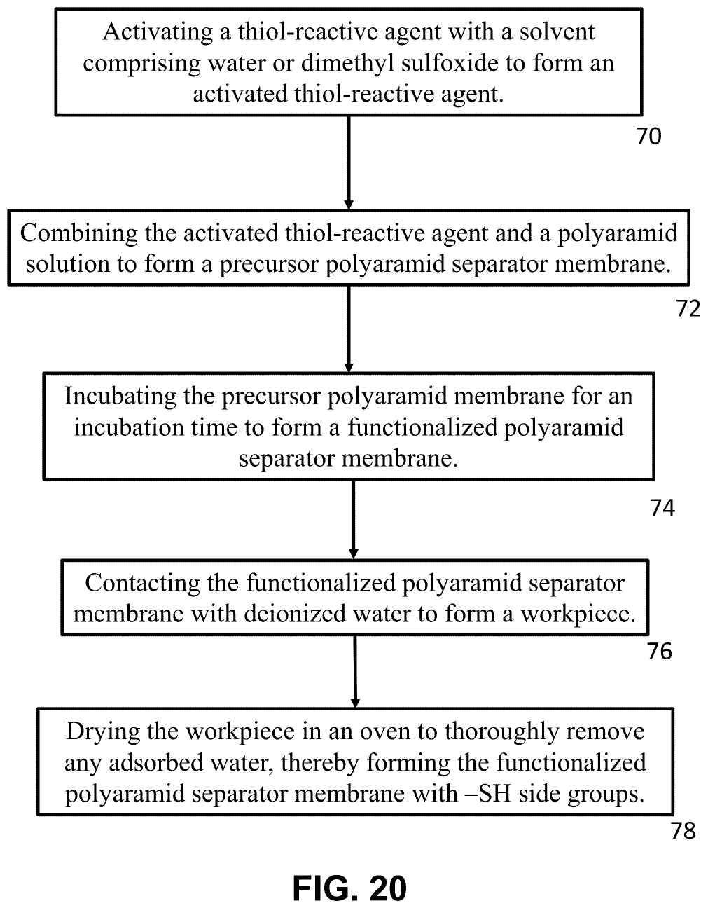

FIG. 20 shows an example of a process for functionalizing a precursor polyaramid separator membrane with Sulfhydryl (—SH) groups (as illustrated in FIG. 12), which includes:
(1) activating a thiol-reactive agent with a solvent comprising water or dimethyl sulfoxide to form an activated thiol-reactive agent (Step 70);
(2) combining the activated thiol-reactive agent and a polyaramid solution to form a precursor polyaramid separator membrane (Step 72);
(3) incubating the precursor polyaramid membrane for an incubation time to form a functionalized polyaramid separator membrane (Step 74);
(4) contacting the functionalized polyaramid separator membrane with deionized water to form a workpiece (Step 76); and
(5) drying the workpiece in an oven to thoroughly remove adsorbed water, thereby forming the functionalized polyaramid separator membrane with —SH side groups (step 78).

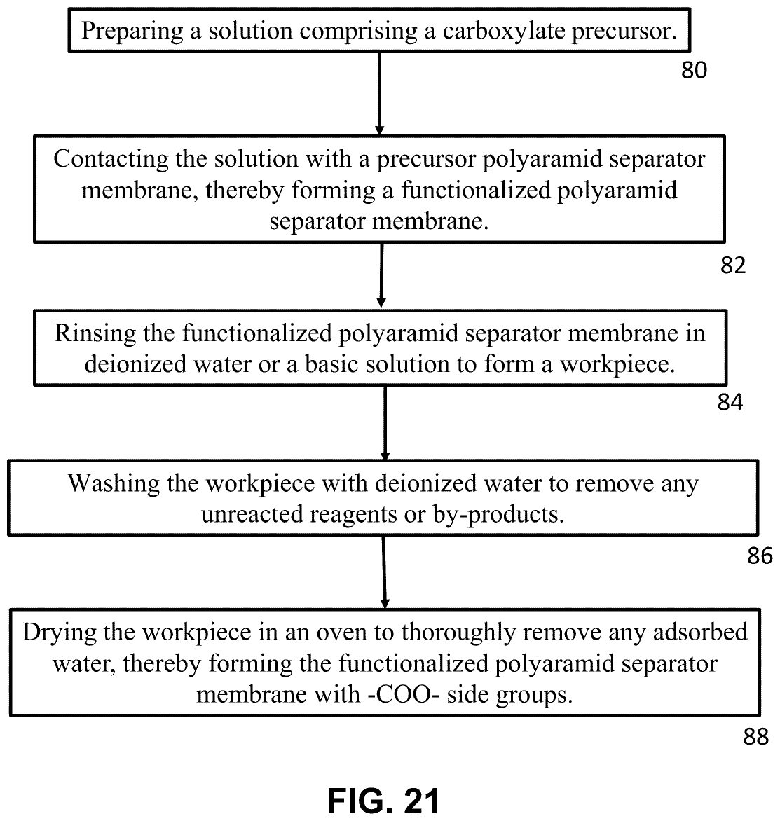

FIG. 21 shows an example of a process for functionalizing a precursor polyaramid separator membrane with Carboxylate (—COO—) groups (as illustrated in FIG. 13), which includes:
(1) preparing a solution comprising a carboxylate precursor (Step 80);
(2) contacting the solution with a precursor polyaramid separator membrane, thereby forming a functionalized polyaramid separator membrane (Step 82);
(3) rinsing the functionalized polyaramid separator membrane in deionized water or a basic solution to form a workpiece (Step 84);
(4) washing the workpiece with deionized water to remove unreacted reagents or by-products (Step 86); and
(5) drying the workpiece in an oven to thoroughly remove adsorbed water, thereby forming the functionalized polyaramid separator membrane with —COO— side groups (Step 88). In some embodiments, the carboxylate precursor used in Step 80 may be acetic acid (CH₃COOH) or succinic anhydride (C₄H₄O₃).

FIG. 22 shows a chemical structure of an example of a polyaramid backbone (meta-aramid) of a separator membrane with metal-trapping side groups (-M) and acid-trapping side groups (-A), according to the present disclosure.

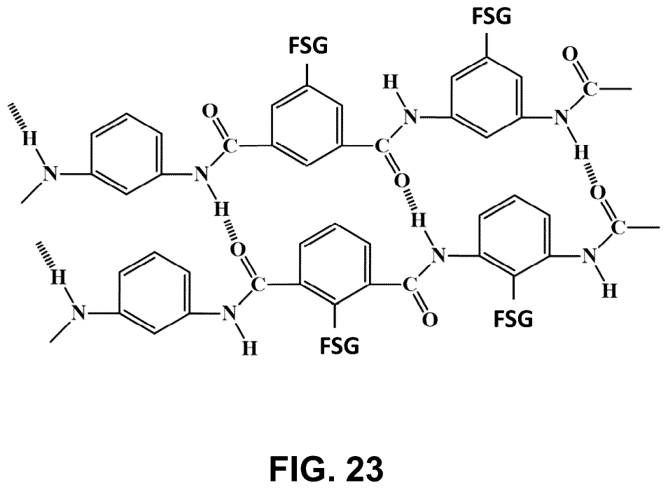

FIG. 23 shows a chemical structure of an example of a polyaramid backbone (meta-aramid) of a separator membrane with functional side groups (-FSG), according to the present disclosure.

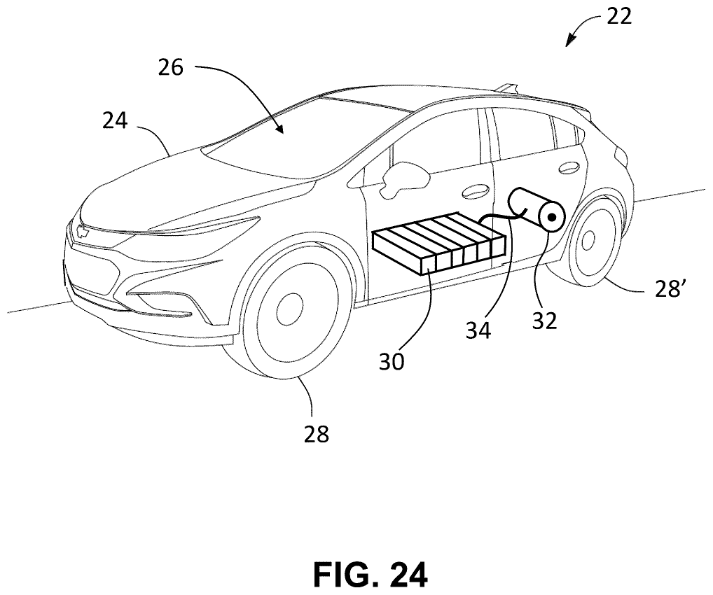

FIG. 24 shows a schematic perspective view of an example of an electric motor vehicle 22 with a rechargeable battery pack 30, according to the present disclosure. Electric motor vehicle 22 includes a vehicle body 24, passenger compartment 26, a plurality of road wheels 28, 28′, etc. attached to vehicle body 24, and a rechargeable battery pack 30 located in a back end of electric motor vehicle 22. Electric motor vehicle 22 further comprises an electric traction motor 32 attached to vehicle body 24 that is operable to drive one or more of the road wheels 28, 28′, etc. that propels electric motor vehicle 22. The rechargeable battery pack 30 is attached to vehicle body 24 and is electrically connected to the traction motor 32 with power cable 34.

HF is a common acidic species in a battery environment. Other acidic species that may be found in battery cells include: Trifluoromethanesulfonic acid (CF₃SO₃H). This acidic species may be formed as a decomposition product of some lithium salts, like lithium bis(trifluoromethanesulfonyl)imide (LiTFSI), which is a common lithium-ion battery salt. Other acidic species may include: acetic acid (CH₃COOH), which may be introduced through impurities or contaminants during the manufacturing process; and formic acid (HCOOH), which may also be a byproduct of some decomposition reactions in the battery.

What is claimed is:

1. A functionalized polymeric separator membrane, comprising:
a polymer backbone chosen from an aramid-based polymer, a polyamide-based polymer, or a polyimide-based polymer, or combinations thereof; and
further including one or more functional side groups (-FSG), wherein the one or more functional side groups are capable of trapping transition metal ions and acidic species, according to (I):

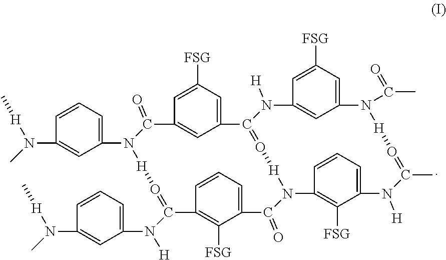

2. The functionalized polymeric separator membrane of claim 1, wherein the polymer backbone comprises a polyaramid backbone defined by two benzene rings joined by a carboxamide group (—C(═O)NH₂), according to (II):

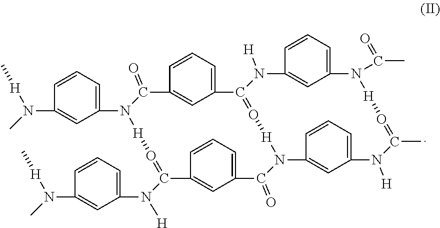

3. The functionalized polymeric separator membrane of claim 2, comprising a urethane derivative side group, according to (III): 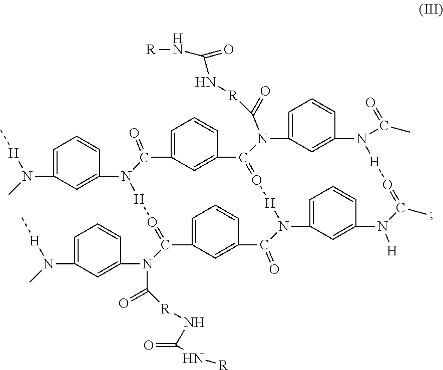
wherein R=an alkyl group, an aromatic group, or a non-reactive group.

4. The functionalized polymeric separator membrane of claim 2, comprising a urea derivative side group, according to (IV): 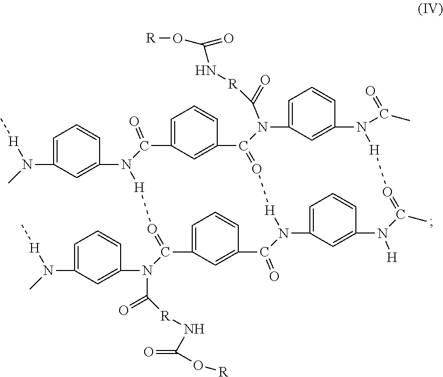
wherein R=an alkyl group, an aromatic group, or a non-reactive group.

5. The functionalized polymeric separator membrane of claim 1, wherein the one or more functional side groups are chosen from:
(a) Sulfhydryl groups (—SH);
(b) Carboxylate groups (—COO—);
(c) Amino groups (—NH₂);
(d) Hydroxyl groups (—OH); or
(e) Pyridine groups (—C₅NH₄);
or a combination thereof.

6. A functionalized polyaramid separator membrane, comprising:
a polyaramid polymer backbone defined by two benzene rings joined by a carboxamide group (—C(═O)NH₂); and further including:
one or more metal-trapping side groups (-M); and
one or more acid-trapping side groups (-A),
wherein the one or more metal-trapping side groups (-M) are capable of trapping transition metal ions; and
wherein the one or more acid-trapping side groups (-A) are capable of trapping acidic species, according to (V):

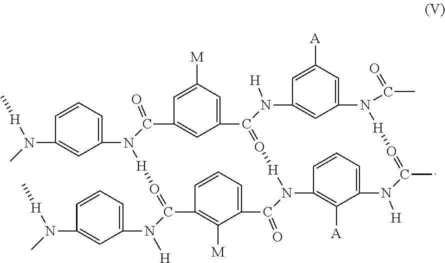

7. The functionalized polyaramid separator membrane of claim 6, wherein the one or more metal-trapping side groups (-M) comprise —SO₃Li, according to (VI):

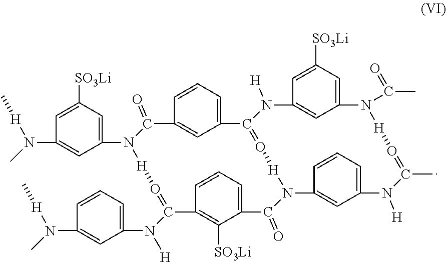

8. The functionalized polyaramid separator membrane of claim 6, wherein the one or more acid-trapping side groups comprise amine groups, (—NH₂), according to (VII):

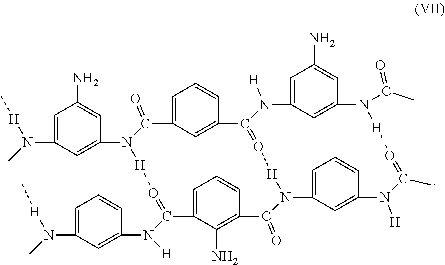

9. The functionalized polyaramid separator membrane of claim 6, wherein the one or more acid-trapping side groups comprise amide derivatives, according to (VII): 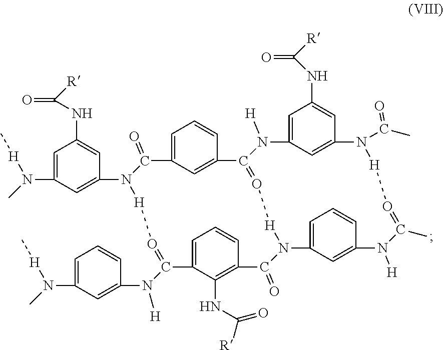
wherein R′=an alkyl group, an aromatic group, or a non-reactive group.

10. The functionalized polyaramid separator membrane of claim 6, wherein the one or more acid-trapping side groups comprise urea derivatives, according to (IX) 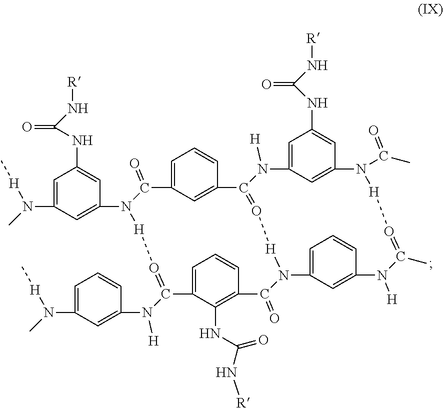
wherein R′=an alkyl group, an aromatic group, or a non-reactive group.

11. The functionalized polyaramid separator membrane of claim 6, wherein the acid-trapping side groups comprise EDTA acid-trapping groups made by treating the polyaramid separator membrane with EDTA anhydrides, according to (X):

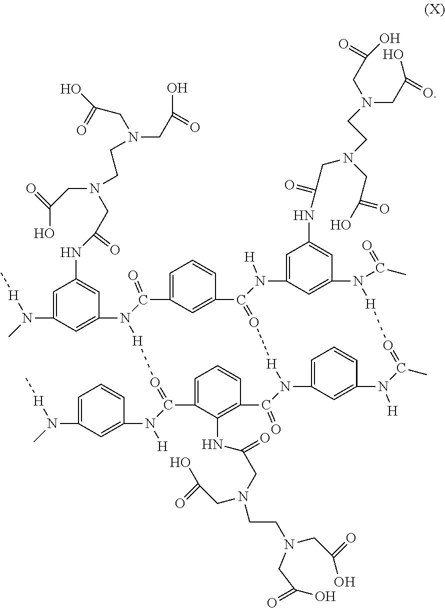

12. The functionalized polyaramid separator membrane of claim 6, comprising
one or more nitrogen atoms; and
one or more acid-trapping functional groups attached to the one or more nitrogen atoms;
wherein the one or more acid-trapping functional groups comprise an isocyanate linkage having an amine group, —NH₂, substituted for O══C══N on a diisocyanate linkage, according to (XI): 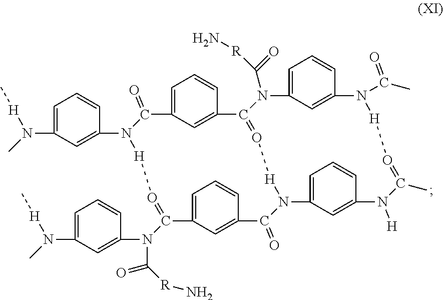
wherein R=an alkyl group, an aromatic group, or a non-reactive group.

13. A method of forming a functionalized polymer separator membrane, the method comprising:
firstly, contacting a solution containing one or more functional side groups with a precursor polymer separator membrane to form a functionalized polymer separator membrane;
secondly, rinsing the functionalized polymer separator membrane in a deionized water or a basic solution to form a workpiece; and
thirdly, drying the workpiece in an oven to thoroughly remove adsorbed water;
thereby forming the functionalized polymer separator membrane with functional side groups.

14. The method of claim 13, wherein the functionalized polymer separator membrane comprises a functionalized polyaramid separator membrane.

15. The method of claim 14,
wherein the solution comprises at least one of sulfuric acid, chlorosulfonic acid, or sulfamic acid, or a combination thereof; and the method further includes:
contacting diluted LiOH or lithium sulfate with the functionalized polyaramid separator membrane to form a workpiece before secondly rinsing the functionalized polyaramid separator membrane in the deionized water.

16. The method of claim 14,
wherein the solution comprises a nitration solution; thereby forming nitrated polyaramid separator membrane; and
secondly, subjecting the nitrated polyaramid separator membrane to a reduction bath to form a reduced workpiece;
thirdly, contacting the reduced workpiece with a deionized water; and
fourthly, drying the reduced workpiece in an oven to thoroughly remove adsorbed water;
thereby forming a nitrated polyaramid separator membrane.

17. The method of claim 16,
wherein the nitration solution comprises a mixture of nitric acid (HNO₃) and sulfuric acid (H₂SO₄); and
wherein the reduction bath comprises sodium dithionate, NaS₂O₄.

18. The method of claim 14, wherein the solution comprises a mixture of Diisocyanate and 1,4-diazabicyclo[2.2.2]octane (DABCO).

19. The method of claim 18, further comprising:
replacing the deionized water with a first solution comprising alcohols that form urethane derivative side groups; or
replacing the deionized water with a second solution comprising amines that form urea derivative side groups.

20. The method of claim 14, further comprising:
mixing a thiol-reactive agent with a solvent including water or dimethyl sulfoxide to form an activated thiol-reactive agent;
wherein the solution comprises the activated thiol-reactive agent; and
combining the solution with a polyaramid solution to form a functionalized polyaramid separator membrane that is functionalized with —SH groups.
